(19) United States
(12) Patent Application Publication
(10) Pub. No.: US 2015/0149705 A1
(43) Pub. Date: May 28, 2015

(54) INFORMATION-PROCESSING SYSTEM

(71) Applicant: Takumi Nito, Tokyo (JP)

(72) Inventor: Takumi Nito, Tokyo (JP)

(73) Assignee: Hitachi, Ltd., Tokyo (JP)

(21) Appl. No.: 14/403,815

(22) PCT Filed: May 25, 2012
(86) PCT No.: PCT/JP2012/003414

§ 371 Date: Nov. 25, 2014

(51) Int. Cl. G06F 3/06

(52) U.S. Cl. CPC G06F 3/061; G06F 3/0688; G06F 3/0659
USPC 711/103

(57) ABSTRACT

Information-processing system including a first information-processing unit, and a second information-processing unit, when the concept of wear leveling is applied to distribution of workloads to the respective information-processing units, the lives of the nonvolatile memories of the first information-processing unit and the second information-processing unit come to ends at almost exactly the same time, comprising a first counter that counts a number of times of writing in the first memory device, and a second counter that counts a number of times of writing in the second memory device, and assignment of workloads to the first information-processing unit and the second information-processing unit is performed based on a replacement time of the first memory device, a replacement time of the second memory device, output of the first counter, and output of the second counter. Thereby, the above described problem is solved.

### TECHNICAL FIELD

This invention relates to an information-processing system, and specifically to management of lives of rewritable nonvolatile memories.

### BACKGROUND ART

In a rewritable nonvolatile memory, the life of writing is limited. Patent Document 1 discloses, in a memory device including a rewritable nonvolatile memory, a technology of evenly averaging numbers of times of writing in respective physical blocks of the nonvolatile memory. The technology of averaging the numbers of times of writing in the respective physical blocks of the rewritable nonvolatile memory is called wear leveling.

### CITATION LIST

### Patent Literature

### PTL 1: Japanese Patent No. 3808842

### SUMMARY OF INVENTION

### Technical Problems

The inventors of the application have found that, in the case of an information-processing system having a first information-processing unit that performs writing of information in a first memory device having a nonvolatile memory and a second information-processing unit that performs writing of information in a second memory device having a nonvolatile memory, when the concept of wear leveling is applied to distribution of workloads to the respective information-processing units, the lives of the nonvolatile memories of the first information-processing unit and the second information-processing unit come to ends at almost exactly the same time, and continuous operation of the information-processing system is obstructed.

### Solution to Problems

An information-processing system of the invention has a first information-processing unit that performs writing of information in a first memory device having a nonvolatile memory, a second information-processing unit that performs writing of information in a second memory device having a nonvolatile memory, a first counter that counts a number of times of writing in the first memory device, and a second counter that counts a number of times of writing in the second memory device, and assignment of workloads to the first information-processing unit and the second information-processing unit is performed based on a replacement time of the first memory device, a replacement time of the second memory device, output of the first counter, and output of the second counter. Thereby, the above described problem is solved.

### Advantageous Effects of Invention

The memory devices including the nonvolatile memories may be replaced while some of information processing units are stopped and running of the other information processing units is continued, and thereby, continuous operation of the information-processing system may be performed.

### BRIEF DESCRIPTION OF DRAWINGS

FIG. 1 is a configuration diagram of an information-processing system as an example of the invention.

FIG. 2 is a flowchart for explanation of an operation example of the information-processing system of the example of the invention.

FIG. 3 shows examples of modules contained in a main memory device of a scheduling node.

FIG. 4 shows examples of programs and data stored in a storage device.

FIG. 5 shows an example of maintenance plan information.

FIG. 6 shows an example of a list of assignment-scheduled workloads.

FIG. 7 shows an example of a workload information table.

FIG. 8 shows an example of a workload assignment table.

FIG. 9 shows examples of modules contained in a main memory device of a test server device.

### DESCRIPTION OF EMBODIMENTS

As below, an example will be explained using the drawings.

### Example 1

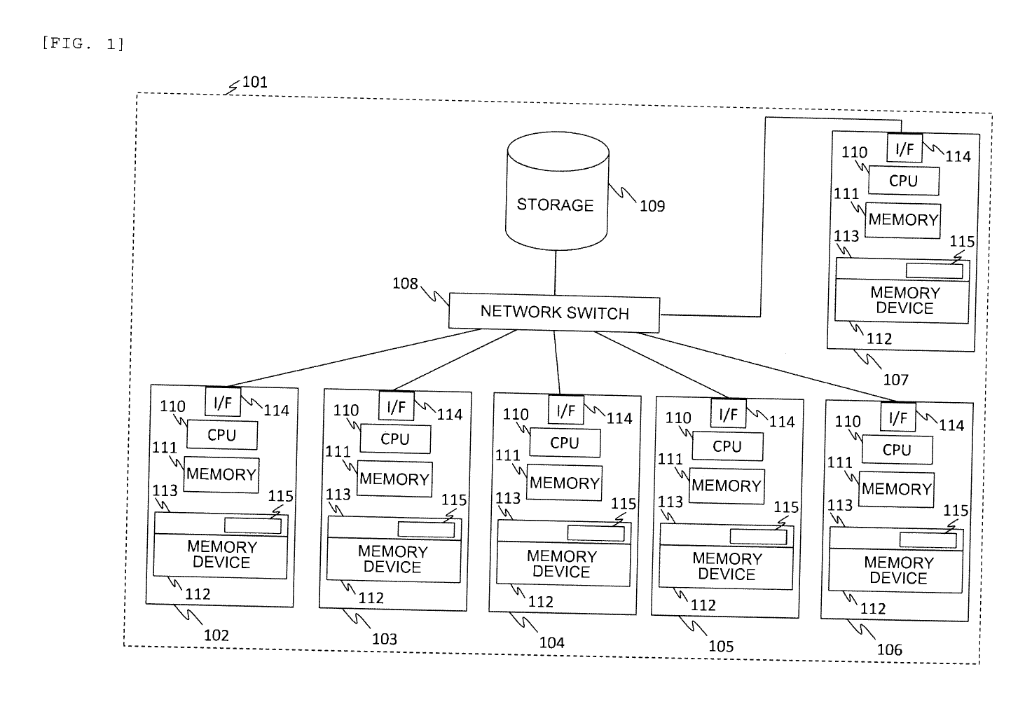

FIG. 1 shows an information-processing system 101 as an example of the invention. The information-processing system 101 has server devices 102 to 107, a network switch 108 as a network device, and a storage device 109. The server devices 102 to 107 and the storage device 109 are connected to each other via the network switch 108. In the example, the number of server devices is six in total, however, the invention may be applied to an information-processing system including two or more server devices. The server devices 102 to 107 have the same specifications in the example for simplicity of explanation. In the example, the server name of the server device 103 is server device A, the server name of the server device 104 is server device B, the server name of the server device 105 is server device C, the server name of the server device 106 is server device D, the server name of the server device 106 is server device D, and the server name of the server device 107 is server device T.

Each of the server devices 102 to 107 has a central processing unit (CPU) 110, a main memory device 111, a memory device 112 having a rewritable nonvolatile memory, a controller 113 of the memory device, a network interface (I/F) 114 for connection to the network switch. In the example, the main memory device 111 includes a DRAM and the memory device 112 includes an NAND flash memory as the rewritable nonvolatile memory. Note that the invention may be applied to an embodiment in which the memory device 112 includes a phase-change memory as the nonvolatile memory. The memory device controller 113 controls writing in the memory device 112 and reading from the memory device 112. Further, the memory device controller 113 has a counter 115 that counts the number of times of writing in the memory device 112 as a controlled object. The respective server devices 102 to 107 may be independently stopped and the memory devices 112 of the stopped server devices are replaceable. Therefore, the memory devices 112 of the stopped server devices may be replaced by new memory devices 112.

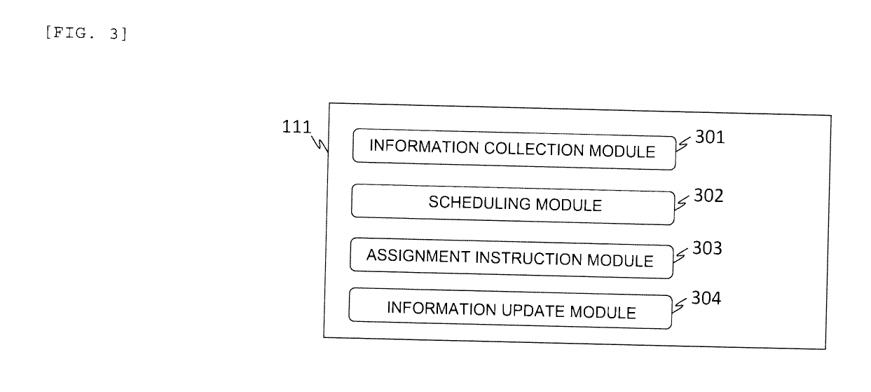

The server device 102 controls assignment of workloads within the information-processing system 101 as a scheduling node. Modules stored in the main memory device 111 of the server device 102 are shown in FIG. 3. In the main memory device 111 of the server device 102, an information collection module 301 that collects information necessary for calculation for assignment of workload from the server devices 103 to 107 and the storage device 109, a scheduling module 302 that determines the workload assignment within the information-processing system 101, an assignment instruction module 303 that gives instructions of workload assignment to the server devices 103 to 106 according to the determined workload assignment, and an information update module 304 are stored.

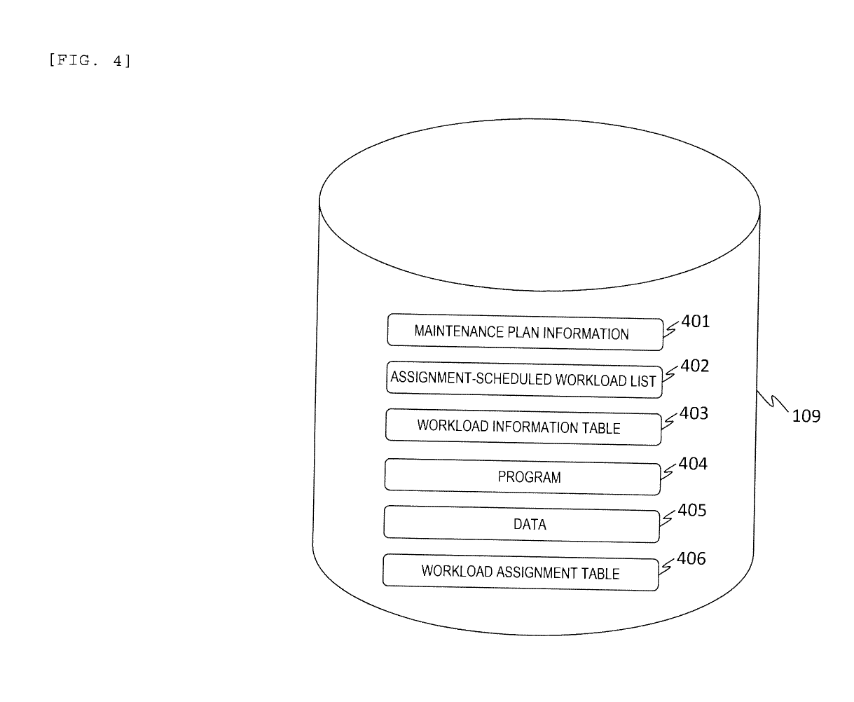

FIG. 4 shows programs and data stored in the storage device 109. The storage device 109 contains maintenance plan information 401 as information corresponding to times and the memory devices 112 to be replaced, an assignment-scheduled workload list 402 as a list of unassigned workloads scheduled to be executed, a workload information table 403 that contains information of amounts of load, execution times, and the number of times of writing of the respective workloads in the memory devices 112, a program 404 necessary for execution of the respective workloads, data 405, and a workload assignment table 406. The amounts of load of the respective workloads contain CPU utilization and memory utilization of the respective workloads. The information of the amounts of load, the execution times, and the number of times of writing of the respective workloads contained in the workload information table 122 is collected by a method, which will be described later, using the server device 107 in the example.

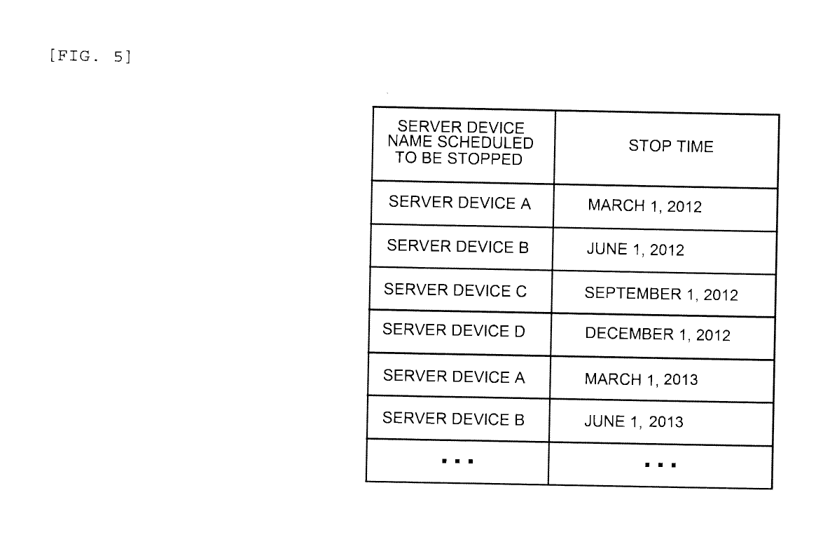

FIG. 5 shows an example of the maintenance plan information 401. The maintenance plan information 401 contains server devices scheduled to be stopped and their stop times as entries. In the example of FIG. 5, first, the server device A is stopped on Mar. 1, 2012. Accordingly, the memory device 112 of the server A may be replaced on Mar. 1, 2012. Then, the server device B is stopped on Jun. 1, 2012. Accordingly, the memory device 112 of the server B may be replaced on Jun. 1, 2012. In the example of FIG. 5, the server devices may be sequentially stopped every three months and the memory devices 112 may be replaced.

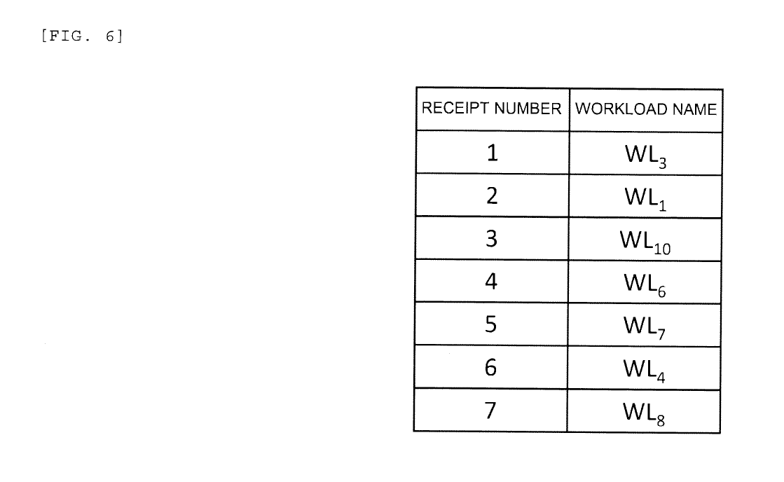

FIG. 6 shows an example of the assignment-scheduled workload list 402. The assignment-scheduled workload list 402 contains receipt numbers as the order of reception of the execution schedules and workload names of the workloads on the information-processing system 101 as entries. FIG. 6 shows that the information-processing system has received workloads in the order of WL₃, WL₁, W₁₀, WL₆, WL₇, WL₄, WL₈.

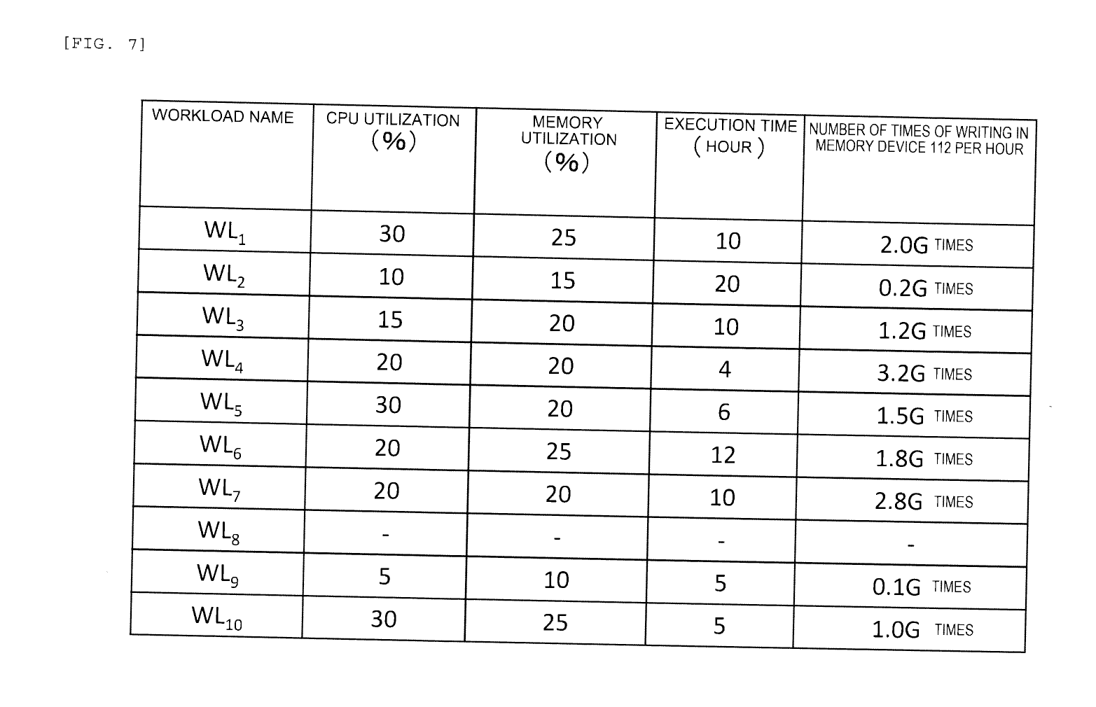

FIG. 7 shows an example of the workload information table 403. The workload information table 403 contains information of workload name, CPU utilization (%), memory utilization (%), execution time (hour), and the number of times of writing in the memory device 112 per hour with respect to each workload. In FIG. 7, for example, the CPU utilization of the workload of the workload name WL₁ is 30%, the memory utilization is 25%, the execution time is 10 hours, the number of times of writing in the memory device 112 per hour is 2.0 G times, i.e., two billion times. Further, regarding the workload of the workload name WL₈, except the workload name, all information of the CPU utilization, the memory utilization, the execution time (hour), and the number of times of writing in the memory device 112 per hour are missing.

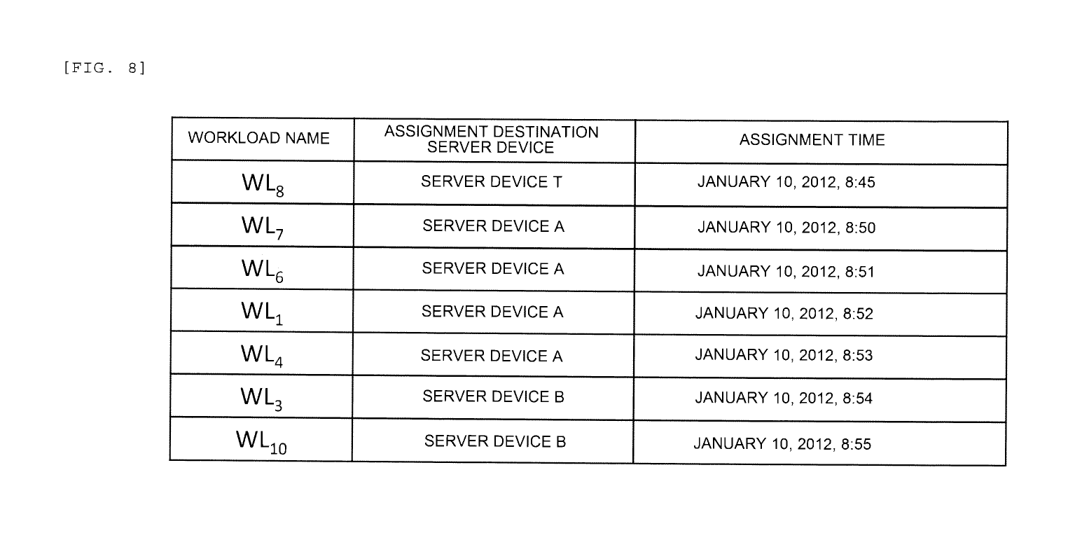

FIG. 8 shows an example of the workload assignment table 406. The workload assignment table 406 contains respective information of the workload names, assignment destination server devices, and assignment times. The example in FIG. 8 shows that the workload of the workload name WL₄ was assigned to the server device A, and was assigned and started at 8:50 on Jan. 10, 2012.

The server devices 103 to 106 as calculation nodes read out the program 404 and the data 405 necessary for execution of the workloads from the storage device 109 according to the assignment instructions from the server device 102 as the scheduling node, and execute the assigned workloads.

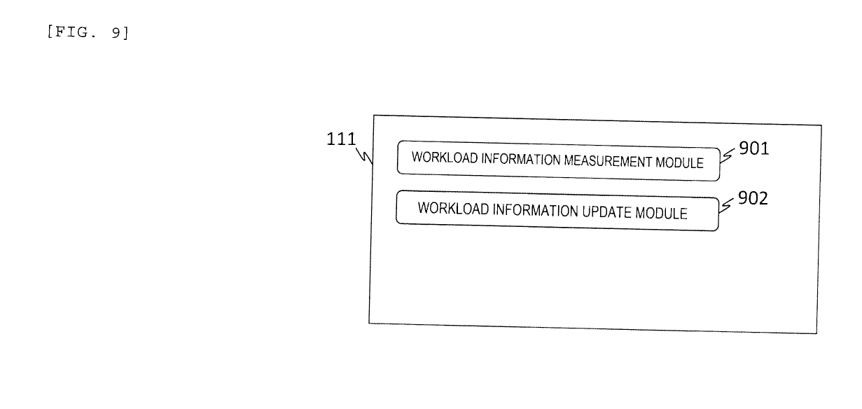

The server device 107 as the test server device collects missing information with respect to the workload lacking at least some of the information of the amount of load of the workload, the execution time, and the number of times of writing in the memory device 112. Further, in the case of the workload with no entry in a workload table 112, the server device 107 also adds anew entry to the workload table 112. Modules stored in the main memory device 111 of the server device 107 are shown in FIG. 9. In the main memory device 111 of the server device 107, a workload information measurement module 901 and a workload information update module 902 are stored.

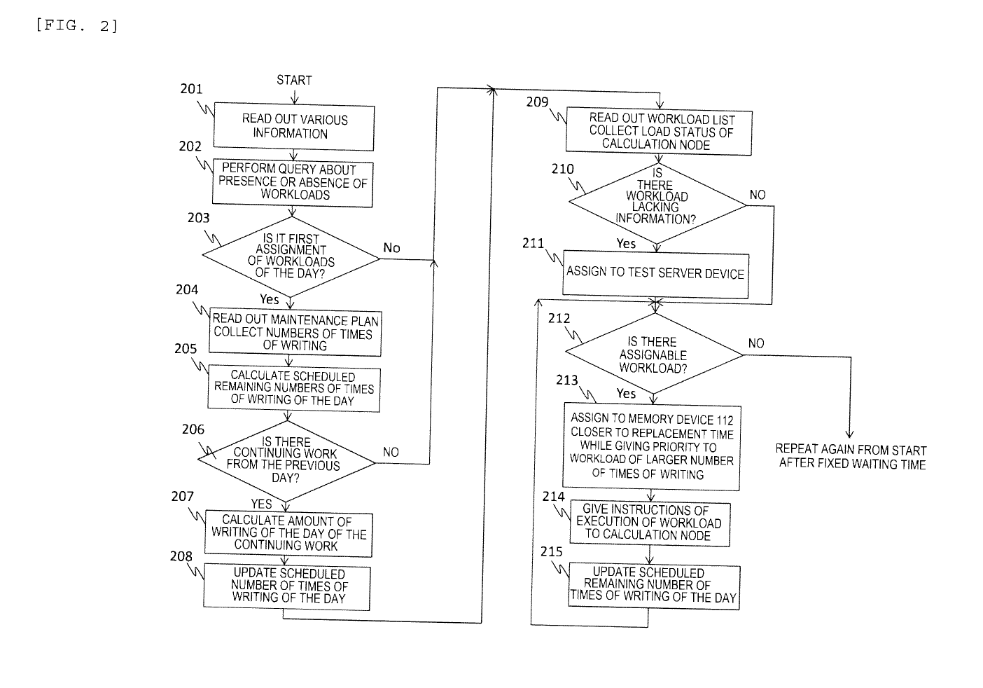

As below, an operation of the information-processing system 101 will be explained using FIG. 2 showing an example of an operation flow of the information-processing system 101.

At step 201, the information collection module 301 of the server device 102 reads out the assignment-scheduled workload list 402, the workload information table 403, and the workload assignment table 406 from the storage 109.

At step 202, the information collection module 301 of the server device 102 sends queries to the server devices 103 to 106 about presence or absence of workloads being executed, and the information update module 304 deletes the entries no longer being executed among the entries of the workload assignment table 406 based on the query results.

At step 203, the server device 102 determines whether or not the workload assignment to be performed is the first assignment of the day. If the workload assignment is the first assignment of the day, the operation of the information-processing system 101 moves to step 204 and, if not, moves to step 209.

At step 204, the information collection module 301 of the server device 102 reads out the maintenance plan information 401 from the storage device 109, and collects the numbers of times of writing in the respective memory devices 112, i.e., the count values as output of the counters 115 from the server devices 103 to 106.

At step 205, the scheduling module 302 calculates the average times of writing per day so that the numbers of times of writing in the respective memory devices 112 may reach the ends of the lives at the scheduled replacement dates of the respective memory devices 112 of the server devices 103 to 106 from the maintenance plan information 401 and the count values of the respective counters 115 obtained at step 204, and sets the calculated numbers of times to the scheduled remaining numbers of times of writing of the day for the respective memory devices 112. Here, the lives in the example are the maximum values of the numbers of times of writing set for the respective memory devices 112, and may be values with margins for securement of reliability.

At step 206, the server device 102 checks whether or not there is a workload being continuously executed from the previous day in the server devices 103 to 106 based on the workload assignment table 406. If there is a workload, the operation of the information-processing system 101 moves to step 207 and, if not, moves to step 209.

At step 207, the scheduling module 302 of the server device 102 calculates the scheduled numbers of times of writing in the memory devices 112 of the day by the workloads being continuously executed from the previous day based on the information of the assignment times of the workloads of the workload assignment table 406 and the execution times and the information of the number of times of writing in the memory device 112 per hour of the workload information table 112.

At step 208, the scheduling module 302 updates the scheduled remaining numbers of times of writing in the memory devices 112 by subtracting the scheduled remaining numbers of times of writing in the memory devices 112 by the workloads being continuously executed from the previous day calculated at step 207 from the scheduled remaining numbers of times of writing for the memory devices 112 of the day set at step 205.

At step 209, the information collection module 301 of the server device 102 reads out the assignment-scheduled workload list 402 from the storage device 109, and collects workload status information with respect to each server device from the server devices 103 to 106. Here, the workload status information is information containing the CPU utilization and the memory utilization of the respective server devices of the server devices 103 to 106 in the example.

At step 210, the scheduling module 302 determines whether or not there is a workload lacking at least some of the information of the workload itself in the workload information table 403 or the information of the amount of load of each workload, the execution time, and the number of times of writing in the memory device 112 among the workloads in the assignment-scheduled workload list 402 read out at step 209. If there is a workload lacking the information, the operation of the information-processing system 101 moves to step 211 and, if there is no workload lacking the information, moves to step 212.

At step 211, the scheduling module 302 determines distribution of the workload determined to lack the information at step 210 in the test server device 107. Further, the assignment instruction module 303 gives instructions of execution of the workload to the server device 107 as the test server device and executes addition of the entry of the workload in the workload assignment table 406 and deletion of the entry of the workload from the assignment-scheduled workload list 121. The server device 107 acquires the program 404 and the data 405 for execution of the workload from the storage device 109 and executes the workload. In the examples shown in FIGS. 6, 7, and 8 in the example, the workload WL₈ lacks the respective information in the workload information table 403 and the workload WL₈ is distributed to the server device T. Though the step is not shown in the flowchart of FIG. 2, the respective information of the workload information table 403 of the workload executed in the test server device 107 is measured by the workload information measurement module 901, and the workload information update module 902 updates the respective information of the workload information table 403 based on the measurement result. Note that, if the workload information table 403 contains no information of the workload itself, i.e., no entry, the workload information update module 902 also adds the entry.

At step 212, the scheduling module 302 of the server device 102 determines whether or not there is an assignable workload to the server devices 103 to 106 among the unassigned workloads in the assignment-scheduled workload list 402 read out at step 209. The determination of assignability is performed based on the value of the scheduled remaining number of times of writing in each memory device 112 and the workload information table 403, in the example, performed based on information of the CPU utilization, the memory utilization, the execution time, and the number of times of writing in each memory device 112 per hour as the amount of load of the unassigned workload and the values of the CPU utilization, the memory utilization, the execution time, and the scheduled remaining number of times of writing in each memory device 112 of the respective server devices.

If at least one server device of the server devices 103 to 106 has room in the workload status and there is an unassigned assignable workload, the operation of the information-processing system 101 moves to step 213. If any server device of the server devices 103 to 106 has no room in the workload status and there is no unassigned assignable workload, or if there is no unassigned workload, the flow is executed again from step 201 after a fixed waiting time.

At step 213, the scheduling module 302 of the server device 102 determines assignment to the server device closer to the stop time, i.e., having the memory device 112 closer to the replacement time by giving priority to the workload with the larger number of times of writing in the nonvolatile memory, i.e., the workload with the larger number of times of writing in the memory device 112 of the day in the example among the assignable workloads calculated at step S212 based on the workload information table 403.

The examples shown in FIGS. 5, 6, 7, and 8 are the case where the value of the scheduled remaining number of times of writing in the memory device 112 with respect to the server device A is 100 G times and the value of the scheduled remaining number of times of writing in the memory device 112 with respect to the server device B is 50 G times, the workloads WL₇, WL₆, WL₁, and WL₄ are assigned in the descending order of the number of times of writing in the memory device 112 of the day to the server device A as the server device closest to the stop time, i.e., having the memory device 112 closest to the replacement time. The sum of the CPU utilization, the sum of the memory utilization, and the sum of the numbers of times of writing in the memory device 112 of the day of the workloads WL₇, WL₆, WL₁, and WL₄ respectively fall within allowable ranges. Regarding the remaining workloads WL₃, WL₁₀, they do not fall within the allowable ranges in the server device A, and the workloads are assigned to the server device B second closest to the stop time, i.e., having the memory device 112 second closest to the replacement time. In this manner, the workloads with the larger number of times of writing in the memory device 112 of the day are assigned to the server device having the memory device 112 closer to the replacement time while giving priority, and thereby, the finite lives of the memory devices 112 may be more effectively used and the memory device 112 may be replaced than those in the case where the workloads with the larger numbers of times of writing in the memory device 112 of the day are assigned without giving priority to the server devices having the memory devices 112 closer to the replacement time while giving priority. Note that, even in the case where the workloads with the larger numbers of times of writing in the memory device 112 of the day are assigned without giving priority to the server devices having the memory devices 112 closer to the replacement time while giving priority, the larger numbers of times of writing in the nonvolatile memories occur in the server devices closer to the replacement time on average, and the finite lives of the memory devices 112 may be effectively used.

At step 214, the assignment instruction module 303 of the server device 102 gives instructions to start execution of workloads to the server devices 103 to 106 according to the assignment of the workloads determined at step 213. Further, the assignment instruction module 303 that has given instructions of assignment of the workloads executes addition of the entry of the workload in the workload assignment table 406 and deletion of the entry of the workload from the assignment-scheduled workload list 121. The server devices 103 to 106 to which the instructions to start execution of workloads have been given read out the program 404 and the data 405 necessary for execution of the respective workloads from the storage device 109, store them in the main memory devices 111 and the memory devices 112 within the server devices, and start execution of the workloads.

At step 215, the scheduled numbers of times of writing in the respective memory devices 112 in the remaining time of the day by the workloads assigned at step 214 are calculated from the assignment times of the workload assignment table 406 and the numbers of times of writing in the memory devices 112 per hour of the workload information table 403, the calculation results are subtracted from the scheduled remaining numbers of times of writing in the respective memory devices 112 of the day, and the values of the scheduled remaining numbers of times of writing in the respective memory devices 112 of the day are updated. After step 215, the information-processing system 101 returns to step 212 and executes the flow again.

As described above, the numbers of times of writing in the respective memory devices 112 are not controlled to be averaged, but the workloads are distributed based on the replacement times of the respective memory devices 112, and thereby, the memory devices 112 may be replaced while some of information processing units are stopped in a planned manner based on the replacement times and running of the other information processing units is continued, and the continuous operation of the information-processing system 101 may be performed.

### REFERENCE SIGNS LIST

101: information-processing system, 102-107: server devices, 108: network switch, 109: storage device, 110: central processing unit (CPU), 111: main memory device, 112: memory device, 113: controller of memory device, 114: network interface (I/F), 115: counter.

1. An information-processing system comprising:
a first information-processing unit that performs writing of information in a first memory device having a nonvolatile memory;
a second information-processing unit that performs writing of information in a second memory device having a nonvolatile memory;
a first counter that counts a number of times of writing in the first memory device; and
a second counter that counts a number of times of writing in the second memory device,
wherein assignment of workloads to the first information-processing unit and the second information-processing unit based on a replacement time of the first memory device, a replacement time of the second memory device, output of the first counter, and output of the second counter.

2. The information-processing system according to claim 1, wherein the workloads are distributed while giving priority to one of the first memory device and the second memory device closer to the replacement time.

3. The information-processing system according to claim 1, wherein the workloads with larger numbers of times of writing in the nonvolatile memory among the workloads scheduled to be assigned are distributed while giving priority to one of the first memory device and the second memory device closer to the replacement time.

4. The information-processing system according to claim 1, wherein the first information-processing unit and the second information-processing unit are server devices.

5. The information-processing system according to claim 1, wherein the nonvolatile memory provided in the first memory device and the nonvolatile memory provided in the second memory device include flash memories.

6. The information-processing system according to claim 1, wherein the nonvolatile memory provided in the first memory device and the nonvolatile memory provided in the second memory device include phase-change memories.

7. The information-processing system according to claim 1, comprising a storage device that stores information of the replacement time of the first memory device and information of the replacement time of the second memory device.
